(19) United States
(12) Patent Application Publication
(10) Pub. No.: US 2003/0173478 A1
(43) Pub. Date: Sep. 18, 2003

(54) Glove stand

(76) Inventors: Juanita C. Williams, Boulder City, NV (US); Donna Pacileo, Boulder City, NV (US)

Correspondence Address: WEIDE & MILLER, LTD., 7251 W. LAKE MEAD BLVD., SUITE 530, LAS VEGAS, NV, 89128, US

(21) Appl. No.: 10/100,941

(22) Filed: Mar. 18, 2002

(51) Int. Cl. F16M 11/00; F26B 25/00

(52) U.S. Cl. 248/176.1; 34/106

(57) ABSTRACT

A glove stand and method of holding gloves is disclosed. In one embodiment, the glove stand comprises a base having a support for mounting to a support surface and an arm mount. First and second arm generally “L”-shaped are movably mounted to the arm mount. The arms extend outwardly from the arm mount and then upwardly to define a portion for accepting a glove. In one embodiment, a projection mount is connected to the free end of the upwardly extending portion of each arm, and between two and four projections extend from each projection mount for engaging at least two portions of the inside of a glove placed thereon. The glove mount may be mounted to a horizontal or vertical surface and the arms moved to ensure that gloves placed thereon are stored upright. The projection mounts and projections may be formed as ornamental elements, permitting the user to customize the glove stand to their taste.

### FIELD OF THE INVENTION

The present invention relates to a glove stand and, more specifically, a glove stand particularly designed to store and dry gloves when not in use.

### BACKGROUND OF THE INVENTION

There are many tasks, whether they occur at home or at work, that produce the need and/or desire to wear reusable gloves. These gloves are frequently made of cotton, leather or of rubber, latex or similar materials so as to be waterproof. For instance, individuals often wear gloves when washing dishes, cleaning the bathroom and gardening. During use, however, moisture often forms within the gloves, or the gloves become dirty and must be washed. This requires that the gloves be dried before their next use. In addition, between uses, the gloves must be stored.

Unfortunately, there is no convenient means to dry wet gloves, store wet gloves while they dry, or more generally a means to store gloves between uses. Commonly, once a user is done using the gloves, the gloves often get left inside a sink, or are placed on a surface such as a counter top to dry. After they dry they are often placed inside a cabinet or drawer, making it difficult to locate the gloves for future use. In addition, when stored in this manner, the gloves are often folded or bunched. When folded or bunched, trapped moisture may result in mildew, and adjacent portions of a glove may “bond,” making it difficult later to straighten the glove and place a hand inside of it.

Although some devices have been proposed for drying and storing of gloves, none of these devices have proven effective mainly for the reason that they are often difficult to use and frustrating to employ.

One example of a glove drying device is illustrated in U.S. Pat. No. 3,409,142 to Mechaneck. This device is not particularly effective or easy to use since it is difficult to properly locate the glove on the device. The Mechaneck stand has holder which are broad or wide, filling the space withing a glove which is placed thereon. This makes it difficult to place the glove on the holder, because there is friction and, depending on the size of the glove, interference. Use of the Mechaneck device requires that a user align the four fingers of a glove with four fingers of the device, a difficult process made more difficult when the gloves are wet. The difficulty of properly locating the glove on the holder may result in the user getting water everywhere, even though this is one of the main purposes that the device is intended to prevent. Also, because a glove so snugly fits on the holder, water can not freely drain from the glove. Trapped moisture may not dry, and may cause mildew. The holder is also not configured for use in the various areas where the gloves are likely to need to be used.

Very frequently, gloves are used in the kitchen, washrooms and the like. The prior art does not address a means for storing and drying gloves suitable in the kitchen. Such a device must be convenient to use, including being adaptable to the varying configurations of a kitchen. For example, if the device is to be located on a counter top or similar area, it must be visually appealing. If the device is to be located in an enclosed area, the device must be adaptable to that area. The prior art does not address these problems.

A device and method for drying and storing gloves is desired.

### SUMMARY OF THE INVENTION

The present invention is a glove stand for storing and drying gloves of the type used to wash dishes and engage in other activities, and a method of using a glove stand of the invention, including a method of drying and storing gloves.

In general, the glove stand includes a base or stand and at least one glove engaging member extending from the stand. The position of the glove engaging member is adjustable so that it can be oriented vertically, regardless of whether the stand is supported by a vertically or a horizontally extending surface.

In one embodiment, the glove stand includes a base or stand. The base has two portions: a support or mounting plate and an arm mount. A bottom surface of the support is arranged to mount to a support surface. The arm mount extends from a top surface of the support.

A pair of arms are movably connected to the arm mount. In one embodiment, each arm is generally “L” shaped, having a first portion which extends outwardly from the arm mount in a plane generally parallel to the top surface of the support, and a second portion which extends generally perpendicular to the first portion.

In one embodiment, the arm mount has a passage extending there through, the passage extending in a plane parallel to the top surface of the support. The first portion of each arm engages the passage and is rotatable within the passage relative to the arm mount. In one embodiment, the first portions of the arms are connected to one another, such as within this passage.

The second portions of the arms each have free ends. In one embodiment, a projection mount is connected to the free end of each arm. At least two, and preferably no more than four projections extend outwardly, preferably generally vertically from the arm (i.e. in generally the same direction as the second portion of each arm). The projections are spaced from one another and adapted to engage portions of the interior of a glove.

In one embodiment, each projection mount and associated projections are formed as an ornamental element, such as a rabbit's head, cactus or the like. In one embodiment, these ornamental elements are removably connected to the arms so that they may be inter-changed.

In one embodiment, means are providing for fixing the position of the arms. This means may comprise a fastener extending through a portion of the arm mount and engaging each arm, or when the arms are connected, at least a portion of one of the arms.

In use, the glove stand is mounted to a support surface. The glove stand may be mounted to a substantially horizontal surface simply by placing the support on that surface. In another embodiment, the support is mounted to the support surface, such as with threaded fasteners.

The position of the arms is adjusted so that the second portions of the arms extend vertically for accepting a glove thereon. When the support is connected to a horizontal surface, the arms are moved to a first position in which the second portions thereof extend generally perpendicular to the plane of the top surface of the support (and the support surface). When the support is connected to a substantially vertical surface, the arms are moved to a second position in which the second portions thereof extend generally parallel to the support surface and generally parallel to a plane containing the top surface of the support.

A glove may be lowered onto each arm. Preferably, the interior of each glove is placed over its respective arm. In one embodiment, the projections engage at least two portions of the interior of the glove.

The glove stand provides a convenient place for gloves to be stored and dried. The glove stand is configured so that gloves may easily be placed thereon, and for optimal drying conditions. The glove stand permits the storage of the gloves at locations where gloves are most often used such as on counter tops and inside cabinet doors in rooms like the kitchen, bathroom, garage or workshop.

Further objects, features, and advantages of the present invention over the prior art will become apparent from the detailed description of the drawings which follows, when considered with the attached figures.

### DESCRIPTION OF THE DRAWINGS

FIG. 1 is a perspective view of one embodiment of a glove stand of the invention, the glove stand positioned on a horizontal support surface;

FIG. 2 is a partial perspective view of the glove stand illustrated in FIG. 1 mounted to a vertical support surface, and illustrating movement of glove holding portions of the stand between first and second positions; and

FIG. 3 illustrates a top portion of a glove holding portion of the glove stand illustrated in FIG. 1, and two different ornamental members including glove-engaging projections which may be used therewith.

### DETAILED DESCRIPTION OF THE INVENTION

The invention is a glove stand and a method of using a glove stand. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a device for holding gloves, such as for the purpose of drying and storing them. The device comprises a glove stand including a mounting base or stand and a pair of position-adjustable extensions each adapted to hold a glove.

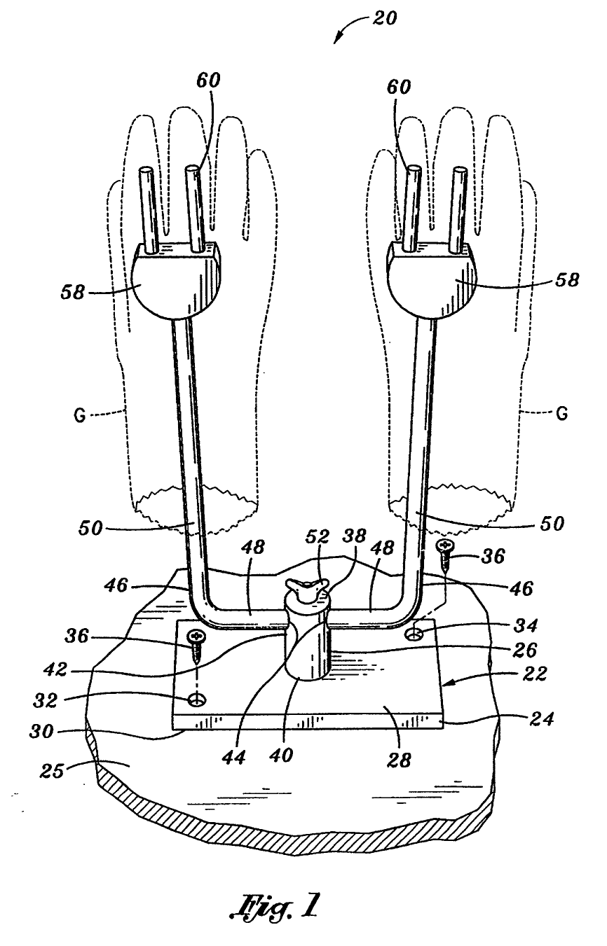

Referring to FIG. 1, there is illustrated a glove stand 20 in accordance with one embodiment of the present invention. As illustrated, the glove stand 20 includes a base or stand 22. In a preferred embodiment the base 22 is comprised of two portions, a support plate 24 and an arm mount 26. The two portions may be integral or two or more separate members which are assembled, as discussed below.

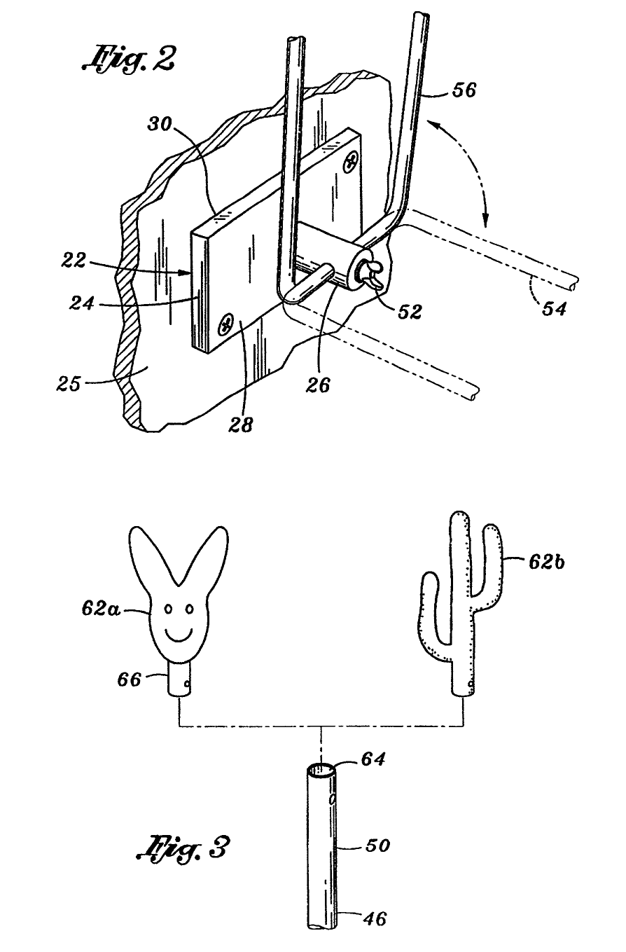

As illustrated, the support plate 24 is generally planar and rectangular in shape. The support plate 24 serves as a support for the glove stand 20, including allowing for fixation of the base 22 of the glove stand 20 to a support surface 25. As will be described in greater detail below, the support plate 24 may be horizontally mounted, for example to a counter top, or as illustrated in FIG. 2, vertically mounted, for example to the inside of a cabinet door.

The support plate 24 has a top surface 28 and a bottom surface 30. The bottom surface 30 is generally planar allowing for the base 22 of the glove stand 20 to abut the support surface 25 which supports it.

As described below, the glove stand 20 may be supported simply by placing the support plate 24 on the support surface 25, such as a counter-top. In one embodiment, however, means are provided for connecting the glove stand 20 to the support surface 25 in a fixed manner. In one embodiment, apertures 32,34 are provided through the support plate 24. A single aperture or a greater number of apertures may be provided. Each aperture 32,34 accepts there through a threaded fastener 36, such as a screw, to mount the base 22 to the support surface 25.

In a preferred embodiment each threaded fastener 36 is arranged to pass through the top surface 28 of the support plate 24 and into the support surface 25 As described in detail below, when each fastener 36 is engaged or tightened, the fastener 36 affixes the support plate 24 to the support surface 25.

It is contemplated that a variety of other means may be provided for connecting the glove stand 20 to a support surface. First, threaded fasteners 36 may be utilized by passing them directly through the support plate 24 rather than through apertures therein. Nails, adhesive or the like may alternatively be utilized.

In a preferred embodiment, the arm mount 26 is attached to the front surface 28 of the support plate 24. The arm mount 26 extends outwardly from the front surface 28 of the support plate 24. Preferably, the arm mount 26 has a top portion 38 and a bottom portion 40. As illustrated, the arm mount 26 is cylindrically shaped and as such has an exterior surface 42 located between the top portion 38 and bottom portion 40.

The bottom portion 40 of the arm mount 26 is attached to the top surface 28 of the support plate 24. In one or more embodiments, the arm mount 26 may be integrally formed with the support plate 24, with the bottom portion 40 extending therefrom. In another embodiment, the arm mount 26 is connected to the support plate 24, such as by connection of the bottom portion 40 to the support plate 24. In one embodiment, a threaded fastener is passed through the support plate 24 from the bottom surface 30 into the bottom portion 40 of the arm mount 26. A counter-sunk recess (not shown) may be formed in the bottom surface 30 of the support plate 24 in alignment with the arm mount 24 which accepts the head of the threaded fastener. In this manner, the threaded fastener does not protrude beyond the planar bottom surface 30 of the support plate 24.

In a preferred embodiment, a passage 44 extends through the arm mount 26. In one or more embodiments, the passage 44 is circular in cross-sectional shape. In a preferred embodiment, the passage 44 extends through the arm mount 26, parallel to the top portion 38 of the arm mount 26, defining opposing openings in the exterior surface 42. The shape of the passage 44 is preferably of the same shape or is of a complimentary shape allowing glove-engaging portions of the glove stand 20 to fit into the passage 44.

The glove stand 20 includes a pair of arms 46 each configured to support a glove G. The arm mount 26 is used to connect the pair of arms 46 to the support plate 24.

In one or more embodiments, each arm 46 has two portions. When connected to the arm mount 26, a first portion 48 of each arm 46 extends outwardly from the mount 26, while a second portion 50 of the arms 46 extends upwardly. In one embodiment, the arms 46 are generally L-shaped. This L-shape configuration with the first portion 48 of the arms 46 extending outwardly, as described in greater detail below, causes the arms 46 to be separated by a sufficient distance from one another to allow for the placement of gloves G thereon without interference.

In one embodiment, each arm 46 is generally rod-like, having a circular cross-section. The arms 46 may be constructed of a wide variety of materials. In one embodiment, the arms 46 are constructed of plastic so as to resist degradation when exposed to moisture from the gloves G placed thereon. In one embodiment, each arm 46 extends outwardly from the arm mount 26 about 1.0-4.0 inches, preferably extending outwardly 2.0 inches, so that the total separation between the upwardly extending portion of the arms 46 is a minimum of about 2.0-8.0 inches. Preferably, the total separation being 4.0 inches.

In one embodiment, each arm 46, including an extension mount discussed below, extends upwardly about 10.0-15.0 inches, preferably extending upwardly 11.0 inches. The length of each arm 46 may vary, but is preferably sufficient to accept a glove G there over and maintain it above the outwardly extending portion of the arm. Preferably, the arms 46 extend upwardly a sufficient distance so that the bottom of gloves G placed thereon is above the support plate 24, leaving the bottom ends of the gloves G open and allowing air to enter the gloves and moisture to flow from the gloves.

The arms 46 may have other dimensions and may be of other shapes, such as square, tubular or the like. Preferably, the arms 46 have a small dimension so that they do not fill the interior space of the glove G, allowing air to circulate in the gloves G and permitting water or moisture to exit the gloves G. In one embodiment, the arms 46 have a cross-sectional diameter of only about 0.25-1.0 inches, preferably having a cross-sectional diameter of 0.4-0.5 inches.

In one or more embodiments, the arms 46 are connected to one another. In one embodiment the arms 46 connect to one another within the passage 44. In other embodiments, the arms 46 do not connect to one another.

Preferably, the position of each arm 46 relative to the arm mount 26 and support plate 24 is adjustable. In the embodiment illustrated, the arms 46 are rotatable within the passage 44 with respect to the arm mount 26. In one embodiment, means are provided for fixing the arms 46 in a particular position. As illustrated, this means comprises an arm mount fastener 52. The arm mount fastener 52 comprises a threaded member which mates with threads on a wall of a passage (not visible) which extends from the top portion 28 of the arm mount 26 into the passage 44. The arm mount fastener 52 passes through this threaded passage into the passage 44 where it engages a portion of each arm 46 located within the passage 44.

The arms 46 may be connected to the arm mount 26 in other manners than described. In the embodiment illustrated, the arms 46 are connected at the arm mount 26 and rotate with one another. In another embodiment, each arm 46 may be connected to an exterior mount associated with the arm mount 26, or engage a short passage extending into each side of the arm mount 26. Other means may be provided for adjusting the position of the arms 46. For example, an end of the arms 46 at the arm mount 26 may be provided with notches for engaging a catch on the arm mount 26, permitting the arms 46 to be rotated in a “ratcheting” arrangement between various positions. In this arrangement, the arms 46 are not connected and may be moved independent from one another.

Referring to FIG. 2, in a preferred embodiment, the arms 46 may be located in a first position 54 in which they extend in a plane which is perpendicular to the top surface 28 of the support plate 24 and the support surface 25. As illustrated in FIG. 1, in this position the arms 46 are generally vertically extending.

Referring again to FIG. 2, in a preferred embodiment, the arms 46 may be located in a second position 56 in which they are located in a plane which is generally parallel to the top surface 28 of the support plate 24 and the support surface 25.

Preferably, the arms 46 may be located in a plurality of positions between these first and second positions 54,56. In particular, when the arm mount fastener 52 is loosened or disengaged, the arms 46 may be moved between the first position 54 and the second position 56 or positions there between. By tightening or re-engaging the arm mount fastener 52, the arms 46 are maintained in the desired position. While the arms 46 may be placed in any position between the first 54 and second 56 position as illustrated, as described below, certain positions are generally more effective when using the glove stand 20 in accordance with the preferred method of use.

In one or more embodiments, as illustrated in FIG. 1, each arm 46 has a free end opposite the end which connects to the arm mount 26. In one embodiment, a projection mount 58 is attached to this free end of each arm 46. The projection mount 58 may be integrally formed with the second portion 50 of the arms 46, or may be selectively connectable and removable to the second portion 50 of each of the arms 46, as described in more detail below.

As illustrated, each projection mount 58 supports at least one, and preferably no more than four, glove-engaging projections 60. In a preferred embodiment there are two projections 60 for each projection mount 58. In one embodiment, each projection 60 comprises an elongate cylindrical member such as a post or rod. Each projection 60 has a first end and a second end. The first end is connected to the projection mount 58. The second end is a free end located generally upwardly in the same direction as the second portion 50 of the arms 56, outwardly from the projection mount 58.

Preferably, the one or more projections 60 are configured to engage the glove G. More preferably, the projections 60 are just long enough to engage a portion of a finger of the glove G placed thereon. Further details regarding the functionality of the projections 60 is provided below. In one embodiment, each projection 60 extends upwardly about 1.0-2.0 inches from its respective mount 58, preferably extending upwardly 1.5 inches. In an embodiment where the projections 60 are generally cylindrical, they preferably have a cross-sectional diameter of about 0.2-0.5 inches preferably having a cross-section diameter of 0.25 inches. Further, in one or more embodiments, each projection is separated apart from each other 0.5-3.0 inches, preferably the separation is 1.0 inches. Preferably, the size and shape of the projections 60 is selected in similar manner to the arms 46: to contact a glove G but permit air circulation and drying. Thus, the projections 60 preferably do not fill the interior space of a glove G, including any of the finger portions thereof.

In one or more embodiments, each projection 60 is selectively connectable and removable from the projection mount 58. For example, the projection mount 58 may include a pair of passages, and the projections 60 may be slip-fit into those passages. In another embodiment, each projection 60 is integrally formed with the projection mount 58.

A wide variety of configurations for the projections 60 are contemplated. In one embodiment, referring to FIG. 3, an ornamental glove engaging element 62 may instead be used in place of the projection mount 58 and projections 60. As illustrated, the ornament element 62 may have a variety of shapes and/or configurations. Preferably, each ornamental element 62 serves the same function as the above-described projection mount 58 and projections 60, thereby serving the same function but in a more aesthetically pleasing way. As such, the ornamental element 62 preferably includes one portion for mating to the free end of an arm 46, and a second portion including at least one outwardly extending glove-engaging projection.

The ornamental elements 62 may have a variety of shapes and configurations. As illustrated, one example of an ornamental glove engaging element 62 is that having the shape of a rabbit's head 62a (the head portion serving as the “projection connector 58”) including a pair of upwardly extending ears (the ears serving as the “projections 60”). Another example of such an ornamental element 62 is the illustrated cactus 62b.

In one embodiment, it is desirable to permit a user to exchange the ornamental glove engaging elements 62 which are used with the glove stand 20. Thus, in one or more embodiments, the ornamental element 62 is disconnectable from the free end of the arm 46. As illustrated in FIG. 3, in one embodiment, the free end of each arm 46 may define a port 64 for accepting a mating stem 66 portion of the ornamental element 62. However, in another embodiment the ornament 62 is integrally formed with the arms 46 of the glove stand 20.

One or more embodiments of the invention comprise a method of using the glove stand 20. One such embodiment comprising use of the glove stand 20 described above will now be detailed.

In a preferred embodiment, the glove stand 20 is mounted to a support surface 25. Preferably, the glove stand 20 illustrated is particularly suited to be used with a generally planar support surface 25. When the support surface 25 is a generally planar horizontal surface, the glove holder 20 may simply be placed on the surface 25 by resting the bottom surface 30 of the support plate 24 on it. In this arrangement, the glove holder 20 need not be attached to the support surface 25 by means for attachment.

In another embodiment, the glove stand 20 is mounted to a surface so as to be securely fixed in position. In a preferred embodiment, the glove stand 20 is fastened into place by the support plate 24. As described above, the bottom surface 30 of the support plate 24 is generally planar. As illustrated in FIGS. 1 and 2, this allows the bottom surface 30 to abut against the support surface 25.

In one embodiment, the glove stand 20 may be mounted to a horizontal support surface 25 as illustrated in FIG. 1. In another arrangement, the glove stand 20 may be mounted to a vertical support surface 25 as illustrated in FIG. 2.

Regardless of the orientation of the support surface 25, the support plate 24 is preferably securely fastened to the support surface 25. As detailed above, at least one fastener 36, such as a screw, is threaded through the at least one aperture 32,34 extending through the support plate 24 until it engages the support surface 25.

In a method of the invention, the position of each arm 46 may be adjusted to facilitate the acceptance of a pair of gloves G. In an arrangement where the support plate 24 is affixed to a horizontal support surface 25, the arms 46 are preferably oriented as illustrated in FIG. 1 in which they extend vertically upward. In an arrangement where the support plate 24 is affixed to a vertical support surface 25, the arms 46 are preferably oriented as illustrated in FIG. 2 in which they also extend vertically upward. In the vertical orientation, the gloves G may easily be lowered onto the arms 46, and moisture in the gloves G is drawn downwardly out of the gloves G.

In addition, in the arrangement illustrated in FIG. 2, the vertical orientation of the arms 46 is also the most space efficient since the arms 46 extend along the cabinet wall and not outwardly into the interior of the cabinet.

If it is desired to change the positions of the arms 46, the arm mount fastener 52 may be disengaged or loosened and the arms 46 moved into the desired position relative to the support surface 25. As it will be appreciated the arms 46 in the preferred embodiment are not moveable independent of one another since the bottom portions 48 of the arms 46 are joined together within the passage 44. However in one or more embodiments, as will be discussed in greater detail below, the arms 46 may move independently of one another.

Once the arms 46 are in their desired position, the arm mount fastener 52 may be re-engaged or tightened to maintain the position of the arms 46. The arms 46 may, of course, be positioned prior to mounting the glove stand 20 to the support surface 25.

As illustrated, each arm 46 and the projections 60 extending from the projection mount 58 connected to each arm 46 are designed to extend upwardly into the interior of the gloves G. Once the arms 46 are in the desired position, the gloves G may be placed over the projections 60 and arms 46. The one or more projections 60, and in some instances the projection mounts 58, engage one or more portions of the glove G. In one embodiment, the projections 60 keep finger portions of the gloves G upright allowing for easy placement of the gloves G and efficient drying.

In accordance with the invention, the projection mount 58 and associated projections 60 may be replaced by an ornament glove engaging element 62. In one embodiment, the projection mounts 58 are removed from the free ends of the arms 46. Other projection mounts 58, such as the above-described ornamental glove engaging elements 62 may then be connected to the free ends of the arms 46.

In accordance with the invention, the glove stand 20 provides a convenient means for drying and storing gloves G. The gloves G may now be conveniently stored in places where the gloves G are used since the glove stand 20 can easily be placed in a variety of locations. These locations can be visible (i.e. the top of a counter) or in non-visible locations (i.e. the inside of a cabinet door).

Further, the glove stand 20 is easy to use. The configuration of the glove stand 20 of the preferred embodiment does not require that each finger be specifically lined-up with a projection for each individual finger associated with a glove. This is an especially difficult task when the gloves are wet and the user is not trying to get water everywhere. Instead the user merely pulls off the gloves G and drops the gloves over the one or more projections 60, the projection connector 58 and arm 46. The user does not need to align the fingers of the glove G with the projections 60, nor does the user need to stretch or pull the gloves 46 over the arms 46 and projections 60 to place the gloves G thereon, unlike in the prior art.

Additional aspects of the glove stand, including arrangements of other embodiments thereof, will now be described.

The glove stand 20, including the various components may be formed from a variety of materials. For example, the components may be constructed of metal, wood, plastic, or other materials, and combinations thereof. It is preferred that the material used is durable and lightweight, including resistant to decay/degradation when exposed to water. In one or more embodiments, the material may be painted or molded in color to be aesthetically pleasing. In the case of the ornamental glove engaging elements 62, color may be used to impart realism to the item being replicated (i.e. green cactus, white rabbit).

In one or more embodiments, the support plate 24 may be other than rectangular. For example, the mount may be square, circular, hexagonal, triangular, and so forth. Preferably, the support plate 24 is of a sufficient size to maintain the glove stand 20 in an upright position when not secured to a support surface 25, or to provide adequate space to mount the glove stand 20 with fasteners or the like.

In another embodiment of the invention, the arm mount 26 may be other than cylindrical in shape. For example, the arm mount 26 may be square, rectangular, triangular or irregular in shape. In accordance with these other embodiments, the arm mount 26 may have a variety of exterior surfaces oriented at various angles with respect to one another.

In one or more embodiments, the passage 44 which accepts the arms 46 may be other than circular, such as square or oval. Preferably, however, the shape of the passage 44 is selected to accept the arms 46 in a manner providing the above-described functionality.

As described, the arms 46 may have a wide variety of shapes and configurations. For example, the arms 46 need not be “L” shaped. In one embodiment, the arms 46 may be “bendable” so as to be flexed between various shapes and positions. In this and other configurations, the arms 46 need not be mounted to an arm mount 26, but may be connected directly to the support plate 24. Further, the arms 46 may be configured in other than an “L” shape and still accomplish the desired function of providing spaced mounts for gloves G, and also mounting the gloves G in a manner which facilitates air flow and drying. For example, the arms 46 could extend in a “V” pattern from the arm mount 26 or support plate 24, their free ends located apart and sufficient far from the plate 24 to facilitate the mounting and drying functions.

The glove stand 20 need not include independent projection mounts 58 or projections 60. For example, the arms 46 may be molded with a free end having an enlarged bulb or other shape for accepting the projections. The projections 60 are desirable since they will generally engage more than one portion of the interior of a glove G and maintain the glove G on the stand 20 in a position in which it is generally aligned over the arm 46.

The projections may also be integrally formed with the arm. Regardless of the configuration, the glove stand 20 preferably includes at least one member, such as an arm, extending outwardly from the support plate 24 for supporting a glove G. Further, the glove stand 20 preferably includes at least two projections extending from the at least one member for engaging two portions of a glove G.

The glove stand 20 may include only a single arm 46, and thus be designed primarily to accept a single glove G. In other embodiments, the glove stand 20 could include multiple arms 46 for accepting more than two gloves G.

The glove stand 20 as described has numerous benefits and advantages. First, as detailed above, the glove stand 20 may be conveniently located in a variety of places for use. These locations include a counter-top, the inside or outside of a cabinet, or a wall. The glove stand 20 is adapted to be mounted to surfaces which are horizontal, vertical or otherwise oriented.

The glove stand 20 is arranged to accept and store gloves G in an optimum position. As indicated, regardless of the orientation of the support surface 25, the arms 46 of the glove stand 20 may be adjusted into a position in which they are vertically extending so as to easily accept gloves G lowered thereon. In this position, moisture in the gloves G is drawn downwardly of the gloves G.

Most importantly, the glove stand 20 is uniquely adapted to accept gloves G. As indicated, there are preferably at least two, and no more than four projections for engaging a glove G on each arm 46. In the most preferred embodiment, only two projections are provided. In this configuration, a user may lower a glove G onto the glove stand 20 without needing to align the thumb and all finger portions of the glove with mating portions of the stand 20. Instead, the glove G simply needs to be placed over the arms 46 as indicated. So positioned, the two spaced apart projections 60 engage two portions of the glove G, maintaining the gloves in an open position in which they do not crease or fold and do not trap moisture.

The glove stand 20 is visually appealing and capable of being used in normal household areas. In one embodiment, ornamental elements 62 may be utilized. These elements 62 are preferably interchangeable, permitting a user to customize their glove stand 20 to their taste, including interior decor, for a particular holiday or the like.

It will be understood that the above described arrangements of apparatus and the method therefrom are merely illustrative of applications of the principles of this invention and many other embodiments and modifications may be made without departing from the spirit and scope of the invention as defined in the claims.

We claim:

1. A glove stand comprising:
a base, said base comprising a support plate having a top surface and a bottom surface, said bottom surface for mounting to a support surface and an arm mount, said arm mount extending from said top surface of said support plate;
a first arms and a second arm, said first and second arms being generally “L”-shaped and having a first portion and a second portion, said first portion mounted to said arm mount and extending outwardly from said arm mount and said second portion of said arm extending generally perpendicular to said first portion;
a projection mount connected to said second portion of each arm; and
between two and four projections extending from each projection mount for engaging at least two portions of the inside of a glove placed thereon.

2. The glove stand in accordance with claim 1 wherein said first arm and second arm extend in generally opposing directions from said arm mount.

3. The glove stand in accordance with claim 1 wherein a passage extends through said arm mount, said passage having a generally circular cross-section and accepting at least a portion of the first portion of said first arm and second arm therein.

4. The glove stand in accordance with claim 1 wherein said first arm and second arm are movably connected to said arm mount

5. The glove stand in accordance with claim 4 including means for selectively fixing the position of the first arm and second arm in a first position wherein said arms lie in a plane extending generally parallel to said top surface of said support or a second position wherein said arms lie in a plane extending generally perpendicular to said top surface of said support.

6. The glove stand in accordance with claim 5 wherein said means for selectively fixing comprises a fastener, said arm mount fastener arranged to extend through said arm mount and engage a portion of the first arm and second arm.

7. The glove stand in accordance with claim 1 wherein said projections and projection mount are configured as an ornament element.

8. The glove stand in accordance with claim 1 wherein said first and second arms each have a first end, said first ends of said arms connected to one another in a passage extending through said arm mount, said first and second arms simultaneously rotatable within said passage for movement between at least a first position in which said arms lie in a plane extending generally parallel to said top surface of said support or a second position wherein said arms lie in a plane extending generally perpendicular to said top surface of said support.

9. A method of storing and drying comprising or using a glove stand having a base and at least one glove engaging member extending from the base comprising:
mounting said base of said glove stand on a support surface;
moving said at least one glove engaging member with respect to said base to a position in which a glove accepting portion thereof extends in a vertical direction; and
locating a glove on said at least one glove engaging member by lowering said glove over said glove engaging member and engaging at least two portions of an interior of said glove with at least two and no more than four glove engaging portions of said glove engaging member.

10. The method in accordance with claim 9 wherein said at least one glove engaging member comprises at least one arm connected to said base and said step of moving comprises rotating said at least one arm with respect to said base.

11. The method in accordance with claim 10 including the step of fixing a position of said at least one arm after said rotating step.

12. The method in accordance with claim 9 wherein said mounting step comprises affixing said base to said support surface with a fastener.

13. A glove stand for supporting a pair of gloves comprising:
a base, said base comprising a support having a top surface and a bottom surface, said bottom surface configured to mount to a support surface, and an arm mount, said arm mount extending outwardly from said top surface of said base, said arm mount having a passage there through extending in a plane generally parallel to said top surface of said base;
a pair of arms, said arms connected at first ends thereof and having first portions located within said passage and extending outwardly therefrom, and second portions extending generally perpendicular to the first potions and each having a free end, said first portions of said arm located in said passage rotatable in said passage with respect to said arm mount;
at least two and no more than four space projections extending generally upwardly from said free end of said arms; and
means for fixing a position of said arms with respect to said arm mount.

14. The glove stand in accordance with claim 13 wherein said projections comprise extending portions of ornamental elements connected to said free ends of said arms.

15. The glove stand in accordance with claim 14 wherein said free ends of said arms include an aperture for removably accepting a portion of said ornamental element.
